(19) United States
(12) Patent Application Publication
(10) Pub. No.: US 2026/0176410 A1
(43) Pub. Date: Jun. 25, 2026

(54) PROCESS FOR PRODUCING FLEXIBLE POLYURETHANE FOAM

(71) Applicant: VITA INTERNATIONAL LIMITED, Greater Manchester (GB)

(72) Inventors: David SPITZER, Greater Manchester (GB); David KÜHNEMANN, Greater Manchester (GB); Manfred HOHENHORST, Greater Manchester (GB); Sam HILL, Greater Manchester (GB)

(21) Appl. No.: 19/127,463

(22) PCT Filed: Nov. 7, 2023
(86) PCT No.: PCT/GB2023/052898

§ 371 Date: May 6, 2025

(30) Foreign Application Priority Data
Nov. 7, 2022 (GB) 2216562.5

(51) Int. Cl. C08G 18/42; C08G 18/16

(52) U.S. Cl. CPC C08G 18/4288; C08G 18/165; C08G 2110/0008; C08G 2110/005; C08G 2110/0058; C08G 2110/0083

(57) ABSTRACT

Process for preparing flexible polyurethane foam using sustainable polyols such as a biopolyol and a recycled polyol composition. The specific balance of biopolyol and recycled polyol composition enables large amounts of recycled polyol composition to be used in the production of the flexible polyurethane foam, whilst enabling a flexible polyurethane foam to be produced which has good properties and maintains its flexible foam structure. Also provided is a flexible polyurethane foam prepared by the process, a flexible polyurethane foam derived from specific sustainable polyols, and to a polyol composition for preparing a flexible polyurethane foam.

### FIELD OF THE INVENTION

The present invention relates to processes for preparing flexible polyurethane foam. The invention also relates to flexible polyurethane foam prepared by the processes, a flexible polyurethane foam derived from specific polyols, and to a polyol composition for preparing a flexible polyurethane foam.

### BACKGROUND AND PRIOR ART

Polyurethane foam is a polymer produced from the reaction of polyols and isocyanates. Polyurethane foam is typically resistant to a wide range of temperatures and has excellent thermal insulation properties. Polyurethane foam is resistant to relatively high load, and to fungi and mould. It is therefore a material that is well suited to construction works including fitting and sealing and insulation.

Polyurethane foam is typically rigid, semi-rigid or flexible.

Rigid polyurethane foam is a highly crosslinked cellular structure, thermoset material which suffers from plastic deformation. The crosslinked polymer structure of rigid polyurethane foam gives the foam its rigidity and strength. Rigid polyurethane foam is not resilient, it does not stretch or bend. It has a low elongation at break. Rigid polyurethane foams do not generally allow air or water to flow through the foam and therefore rigid polyurethane foams are not very breathable but can have good water resistance properties.

Flexible polyurethane foams are elastically deformable materials. Flexible polyurethane foams are used for a wide range of applications including mattresses, furniture and transportation seating, as well as hygiene and medical applications. Flexible polyurethane foam is resilient, it is able to stretch and bend and regain its previous form following compression. Flexible polyurethane foam has a high elongation at break. Flexible polyurethane foams can be made with open or closed cell structure. The flexible foam typically allows air and water to pass through, therefore flexible polyurethane foam is breathable but is not very water resistant.

Semi-rigid polyurethane foams have properties that are in between those of rigid foams and flexible foams.

Flexible polyurethane foams are generally prepared using fossil based polyols. However, there is a desire to reduce the use of fossil based products and to move towards using sustainable or environmentally friendly resources. However, it is not straightforward to simply replace fossil based polyols with sustainable polyols as it can be difficult to maintain the desirable properties of a flexible foam.

There is therefore a need for a process for producing a flexible polyurethane foam which solves some of the aforementioned problems, or at least provides a viable alternative.

### SUMMARY

In a first aspect, there is provided a process for preparing a flexible polyurethane foam comprising: mixing together a biopolyol, a recycled polyol composition, an isocyanate, a catalyst, water and optionally additives to form a mixture; foaming the mixture to form a foamed mixture; and curing the foamed mixture; wherein the ratio of biopolyol to recycled polyol composition is from about 65:35 to about 5:95.

In some embodiments, the ratio of biopolyol to recycled polyol composition is about 60:40, or about 55:45, or about 50:50, or about 45:55, or about 40:60, or about 35:65, or about 30:70, or about 25:75, or about 20:80, or about 15:85, or about 10:90.

In some embodiments, the density of the polyurethane flexible foam is about 15 to 95 kg/m³.

In some embodiments, the biopolyol is selected from the group consisting of a soy based polyol, a sunflower based polyol, a palm based polyol, a rapeseed based polyol, a castor based polyol, a peanut based polyol, tall oil based polyol, and a canola based polyol.

In some embodiments, the recycled polyol composition is derived from recycled polyurethane foam waste.

In some embodiments, the recycled polyol composition comprises about 30 to about 100 wt % recycled polyol and about 0 to about 70 wt % fossil based polyol.

In some embodiments, the flexible polyurethane foam is derived solely from sustainable polyols.

In some embodiments, the process comprises mixing together 5-65 parts biopolyol; 35-95 parts recycled polyol composition; 0-5 parts fossil based polyol; 40-60 parts isocyanate; 1-3 parts catalyst; 2-5 parts water and 0-20 parts additives, wherein the total amount of polyol (recycled polyol composition, biopolyol, and fossil based polyol) is 100 parts.

In some embodiments, the catalyst is a blowing catalyst, and/or a gelling catalyst.

In some embodiments, the additive is selected from the group consisting of foam stabilizer, surfactant, cell regulator, colour, chain extender, filler, flame lamination aid, flame retardant, porosity enhancer, and cell opener.

In a second aspect, there is provided a flexible polyurethane foam prepared by the process of the first aspect.

In a third aspect, there is provided a flexible polyurethane foam derived from a biopolyol, a recycled polyol composition, and an isocyanate, wherein the ratio of biopolyol to recycled polyol composition is from about 65:35 to about 5:95.

In some embodiments, the flexible polyurethane foam of the second or third aspect has a bio-based carbon content as determined by ¹⁴C isotope analysis of from 1.3% to 46%.

In some embodiments, the flexible polyurethane foam of the second or third aspect has a compressive strength of about 1.5 kPa to about 9 kPa, preferably about 2 kPa to about 8 KPa, more preferably about 4 kPa to about 6 kPa.

In some embodiments, the flexible polyurethane foam of the second or third aspect has an air permeability of about 2 to about 2500 L/m²/s.

In a fourth aspect, there is provided a polyol composition for preparing a flexible polyurethane foam, the polyol composition comprising; 5-65 parts biopolyol; 35-95 parts recycled polyol composition; and 0-5 parts fossil based polyol, wherein the total amount of polyol (recycled polyol composition, biopolyol, and fossil based polyol) is 100 parts.

### DETAILED DESCRIPTION

Polyurethane foam is a polymer produced from the reaction of polyols and isocyanates. Polyurethane foam is typically rigid, semi-rigid or flexible.

There is provided herein a process for preparing a flexible polyurethane foam comprising mixing together a biopolyol, a recycled polyol composition, an isocyanate, a catalyst, water and optionally additives to form a mixture; foaming the mixture to form a foamed mixture; and curing the foamed mixture; wherein the ratio of biopolyol to recycled polyol composition is from about 65:35 to about 5:95.

In some embodiments, the process comprises mixing together 5-65 parts biopolyol; 35-95 parts recycled polyol composition; 0-5 parts fossil based polyol; 40-60 parts isocyanate; 1-3 parts catalyst; 2-5 parts water and 0-20 parts additives. The term “parts” is based on the total amount of polyol (recycled polyol composition, biopolyol, and fossil based polyol) being 100 parts. The term “parts” may also be referred to as parts per hundred polyol (pphp).

### Polyols

The term biopolyol is intended to refer to polyols obtained from renewable and/or sustainable resources (for example plants and trees). This is in contrast to fossil polyols which are obtained from non-renewable and non-sustainable fossil fuels.

The biopolyol may be referred to as a sustainable polyol.

Biopolyols may be CO₂ negative in that the renewable and/or sustainable resources from which they are obtained have absorbed more CO₂ than is produced in the synthesis of the biopolyol.

The biopolyol used in the present invention may be any polyol derived from a bio-based renewable and/or sustainable source. The biopolyol may include more than one biopolyol.

The biopolyol may be obtained from, for example, soybean, millet, nuts (e.g. cashew nuts, peanuts etc.), corn, potatoes, citrus fruit (e.g. oranges), woody plants, cellulosic waste, etc., animals, fish, bacteria, fungi, forestry products (e.g. pine and spruce trees, tall oil, castor oil, sugar (sugar beets, sugar cane, etc.), wheat, or any other renewable and/or sustainable resource.

In some embodiments, the biopolyol is selected from the group consisting of a soy based polyol, a sunflower based polyol, a palm based polyol, a rapeseed based polyol, a castor based polyol, a peanut based polyol, tall oil based polyol, and a canola based polyol. In particularly preferred embodiments, the biopolyol is a soy based polyol.

In some embodiments, the biopolyol may be a bio-based basic component of a biopolyol which has been further chemically processed to produce longer-chain polyols. As one suitable example, PETOL V 50-3S is an alkoxylated castor oil, polyether polyol with secondary hydroxyl groups and an average molecular weight of 3000. The content of vegetable oil used as a starter is 30-31%.

The term recycled polyol composition is intended to refer to any polyol which has been obtained from recycling existing polyurethane foam. For example, the recycled polyol composition may be obtained from recycled polyurethane foam waste, for example, soft foam polyurethane waste. The recycled polyol composition may be derived from recycling mattresses. The recycled polyol composition may also be derived from excess polyurethane trim from manufacturing processes.

The recycled polyol composition may be referred to as comprising a sustainable polyol.

The recycled polyol composition may be any recycled polyol composition known in the art. The recycled polyol composition may include more than one recycled polyol composition.

Any method for recycling polyols known in the art can be used to produce the recycled polyol composition. Suitable recycling methods include, by are not limited to, acidolysis, glycolysis and pyrolysis.

The recycled polyol composition may comprise 100% recycled polyol. However, in some recycling processes, it is not possible to obtain 100% recycled polyol. Therefore, in some embodiments, the recycled polyol composition comprises some fossil based polyol and/or additives. In some embodiments, the polyol composition comprises about 40 wt % recycled polyol and about 60 wt % fossil based polyol and additives, or about 50 wt % recycled polyol and about 50 wt % fossil based polyol and additives. In some embodiments, the recycled polyol composition comprises about 40 wt % recycled polyol to about 100 wt % recycled polyol. The additives may include bio-based, partially bio-based, or stripped recycling polyols.

In some specific embodiments, the recycled polyol composition comprises about 30 wt % to about 100 wt % recycled polyol and about 0 wt % to about 70 wt % fossil based polyol. In some embodiments, the recycled polyol composition comprises about 40 wt % to about 50 wt % recycled polyol and about 50 wt % to about 60 wt % fossil based polyol.

The process may also involve adding some fossil based polyol (in addition to any already present in the recycled polyol composition). The fossil based polyol may be a filled polyol. A filled polyol is a fossil-based polyol which contains solid particles to make foams harder. The particles are typically formed in-situ and are usual particles of styrene-acrylonitrile (SAN), polyurea (PHD) and/or Polyurethane (PIPA).

The total amount of polyol (recycled polyol composition, biopolyol, and fossil based polyol) can comprise up to 70% fossil based polyol with the remaining 30% of polyol being recycled polyol composition, and biopolyol. However, preferably, very little fossil based polyol is added and therefore in some embodiments, the total amount of polyol comprises 0% to 5% of fossil based polyol.

Although biopolyols are obtained from renewable and/or sustainable sources, their use still requires the sourcing of new (not recycled) polyols. Instead of sourcing new polyols, there is a strong desire to recycle and reuse and so there is a preference to utilize as much recycled polyol composition as possible in the flexible polyurethane foam. This reduces the amount of waste polyurethane (e.g. mattresses) going into landfill, and cuts down the need to source fresh biopolyols.

However, recycled polyols do not tend to form good flexible foams. The foams that they form do not have good elasticity, resilience and/or elongation. It is not therefore straightforward to simply replace fossil based polyols with recycled polyols (or a recycled polyol composition). Doing so results in a foam which is not flexible, is not breathable, and/or does not have the properties of a flexible foam. For example, the elongation at break of the foam may be reduced and/or the compressive strength may be reduced. This is demonstrated in CN114456344A. CN114456344A relates to the production of a semi-rigid foam, not a flexible foam, and is therefore in a different technical field. Nevertheless, it is discovered that “the more the amount of recycled regenerated polyol, the worse the elongation at break and the worse the compressive strength of the foam”.

Biopolyols also do not tend to make good flexible foams. It is hypothesized that biopolyols have low functionality which leads to a reduced, and slower, ability to crosslink and therefore insufficient crosslinking (gelation) occurs to form a foam. High incorporation of biopolyols therefore leads to a foam with poor physical characteristics. Therefore, it is likewise not straightforward to simply replace fossil based polyols with biopolyols. Doing so results in a flexible foam with a weak structure. Again, CN114456344A demonstrates Comparative Example 1 in which 100% biopolyol was used and it was stated that “the foam flexibility and compressive strength were the worst”.

The present inventors have surprisingly discovered that there is an optimum ratio of biopolyol to recycled polyol composition of from about 65:35 to about 5:95 which enables large amounts of recycled polyol composition to be used in the production of the flexible polyurethane foam, whilst enabling a flexible polyurethane foam to be produced which has good properties and maintains its flexible foam structure.

In some embodiments, the ratio of biopolyol to recycled polyol composition is about 60:40, or about 55:45, or about 50:50, or about 45:55, or about 40:60, or about 35:65, or about 30:70, or about 25:75, or about 20:80, or about 15:85, or about 10:90.

It may alternatively be said that the process for preparing flexible polyurethane foam comprises a ratio of biopolyol to recycled polyol composition of at least about 65:35, or at least about 60:40, or at least about 55:45, or at least about 50:50, or at least about 45:55, or at least about 40:60, or at least about 35:65, or at least about 30:70, or at least about 25:75, or at least about 20:80, or at least about 15:85, or at least about 10:90.

In some embodiments, the process involves mixing about 5-65 parts of biopolyol and about 35-95 parts recycled polyol composition. For example, the process may involve mixing about parts biopolyol and about 95 part recycled polyol composition, or about 10 parts biopolyol and about 90 parts recycled polyol composition, or about 15 parts biopolyol and about 85 parts recycled polyol composition, or about 20 parts biopolyol and about 80 parts recycled polyol composition, or about 25 parts biopolyol and about 75 parts recycled polyol composition, or about 30 parts biopolyol and about 70 parts recycled polyol composition. or about 35 parts biopolyol and about 65 parts recycled polyol composition, or about 40 parts biopolyol and about 60 parts recycled polyol composition, or about 45 parts biopolyol and about 55 parts recycled polyol composition, or about 50 parts biopolyol and about 50 parts recycled polyol composition, or about 55 parts biopolyol and about 45 parts recycled polyol composition, or about 60 parts biopolyol and about 40 parts recycled polyol composition, or about 65 parts biopolyol and about 35 parts recycled polyol composition.

In some embodiments, the mixture formed in the process comprises at least about 35% of recycled polyol composition. In some embodiments, the mixture produced in the process comprises at least about 10% of biopolyol.

The ratio of biopolyol or recycled polyol composition is vital for producing the flexible polyurethane foam. Therefore the present disclosure also provides a flexible polyurethane foam derived from a biopolyol, a recycled polyol composition, and an isocyanate, wherein the ratio of biopolyol to recycled polyol composition is from about 65:35 to about 5:95.

Preferably, the flexible polyurethane foam comprises at least about 35% of recycled polyol composition. Preferably, the flexible polyurethane foam comprises at least about 10% of biopolyol.

Also disclosed herein is a polyol composition for preparing a flexible polyurethane foam, the polyol composition comprising 5-65 parts biopolyol, 35-95 parts recycled polyol composition; and 0-5 parts fossil based polyol, wherein the total amount of polyol (recycled polyol composition, biopolyol, and fossil based polyol) is 100 parts.

Preferably, the polyol composition comprises at least about 35% of recycled polyol composition. Preferably, the polyol composition comprises at least about 10% of biopolyol.

### Isocyanate

The production of flexible polyurethane foam requires the presence of an isocyanate. The isocyanate can be any isocyanate known in the art for polyurethane production.

In some embodiments, the isocyanate is a toluene diisocyanate. For example, the isocyanate may be Desmodur™ T-80 NP isocyanate or Desmodur™ T-65 isocyanate, or a mixture thereof.

In some embodiments, the isocyanate is a methylene diphenyl diisocyanate.

In some embodiments, the isocyanate may be a mixture of a toluene diisocyanate and a methylene diphenyl diisocyanate.

In some embodiments, the process involves mixing 30-60 parts of isocyanate. In preferred embodiments about 45-55 parts of isocyanate are used.

### The Catalyst

The process of the invention requires a catalyst. The catalyst may be any catalyst known in the art for preparing polyurethane foam. The process may include one or more catalysts.

Catalysts for polyurethane systems can be divided into two broad classes: gelling catalysts and blowing catalysts. Gelling catalysts are more selective to catalysing the reaction of the isocyanate with the polyol, whereas blowing catalysts are foaming catalysts; blowing catalysts are more selective to catalysing the reaction of the isocyanate with water to produce foam.

Therefore, in some embodiments, the catalyst in the process is a blowing catalyst and/or a gelling catalyst.

In some embodiments, the gelling catalyst is a metal based catalyst. Preferably, the gelling catalyst is a tin based catalyst. An example of a suitable tin based catalyst is KOSMOS T 900 Made by Evonik.

In some embodiments, the blowing catalyst is an amine catalyst. Preferably, the amine catalyst is a tertiary amine based catalyst. An example of a suitable amine catalyst is DABCO® BL13 by Evonik.

In some embodiments, the process involves mixing 1-3 parts of catalyst. In preferred embodiments, about 2 parts of catalyst are used.

### Water

The process requires the presence of water. Water has the function of reacting with the isocyanate to produce CO₂ which enables foaming to occur.

In some embodiments, the process involves mixing 2-5 parts of water. In preferred embodiments, about 3-4 parts of water are used, more preferably 3.6 parts.

### Additive

The process for preparing flexible polyurethane foam may include one or more additives in the mixture with the biopolyol, recycled polyol composition, isocyanate, catalyst and water.

Additives are optionally included if they would improve the performance of the flexible polyurethane foam, or if they would provide specific properties to the flexible polyurethane foam. Any additive known in the art for flexible polyurethane foam may be used.

In some embodiments, the additive is selected from the group consisting of foam stabilizer, surfactant, cell regulator, colour, chain extender, flame lamination aid, flame retardant, porosity enhancer, and cell opener.

Foam stabilizers may be added to help provide sufficient nucleation and stabilize the expansion of the flexible polyurethane foam. Examples of suitable foam stabilizers include, but are not limited to, polysiloxane, and polyoxyalkylene block copolymers.

Surfactants may be added to help improve the emulsification of the raw materials, prevent coalescence, increase ingredient compatibility and decrease surface tension.

Cell regulators may be added to assist with regulating the size and number of the cells present in the flexible polyurethane foam.

A colour additive may be added if coloured flexible polyurethane foam is desired.

A chain extender and/or crosslinkers may be include in the mixture to increase the length of the polymer chain. A chain extender can aid with improving melt viscosity, improving impact strength and/or increase elongation at break. Suitable chain extenders include, but are not limited to, dipropylene glycol, diethanolamine, and DALTOLAC® grades.

A flame lamination aid may be added to improve the adhesion properties and bonding strength of the flexible polyurethane foam after flame lamination. Examples of suitable flame lamination aids include, but are not limited to, Repi Bonding Enhancer and Momentive™ CS LF.

Flame retardants are widely used additives in polyurethane foams. They are added when it is desirable to reduce the flammability of the flexible polyurethane foam. Examples of suitable flame retardants include, but are not limited to, tris[2-chloro-1-(chloromethyl)ethyl] phosphate (TDCP), phosphate ester containing chemicals such as Fyrol PNX™ from ICL Products, and melamine.

A porosity enhancer may be added to increase the porosity of the foam and therefore increase the flexibility of the foam. Porosity enhancers are often the same as surfactants. In some embodiments herein, the porosity enhancer is a lower activity surfactant.

In some embodiments, a surfactant can be added which can one or more of the above additive functions. In some embodiments, a surfactant can be added which can perform all of the above additive functions.

Flexible polyurethane foam can be an open celled material. Therefore it may be desirable to include a cell opener additive. Cell openers are additives that help to ensure that the foam structure has predominantly open cells, enabling it to ‘breathe’ and to enhance the flexibility of the foam. Cell openers may also be referred to as pore regulators.

In some embodiments, the process involves mixing 0-20 parts of additives. In preferred embodiments, about 5-15 parts of additives are added. In some embodiments, the amount of additives is about 10.5 parts.

### Foaming

Once the biopolyol, recycled polyol composition, isocyanate, catalyst, water and optionally additives have been mixed to form a mixture, the mixture is foamed.

The foaming may be undertaken by any method known in the art. For example, the mixture may be foamed through slabstock, molded, or spray technologies.

Slabstock foaming involves pouring the mixture onto a moving conveyor to form a continuous loaf of foam. The polymer system foams or rises as it spreads across the conveyor. Slabstock foaming can be a continuous process or a discontinuous process like “foam in the box”. Molded foaming is used create products with intricate shapes such as seat cushions. The process is usually a discontinuous process involving pouring or injecting the mixture into a preheated mold. The components react inside the mold causing the polymer system to foam and rise. Spray foaming involves spraying the mixture on a surface or inside a cavity.

### Curing

Once the mixture has foamed, the foamed mixture is subject to curing. Curing is generally a step that simply occurs over time. The foam is allowed to stand and as the foam stands, it produces its own heat which fuels the curing reactions. Generally, curing takes at least 24 hours and it can take up to 14 or even 21 days.

Temperatures reached by the foamed mixture during the curing step can be greater than 150° C., for example, about 155° C. or about 160° C.

### The Foam Produced

There is disclosed herein a flexible polyurethane foam prepared by the process described above. There is also disclosed herein, a flexible polyurethane foam derived from a biopolyol, a recycled polyol composition, and an isocyanate, wherein the ratio of biopolyol to recycled polyol composition is from about 65:35 to about 5:95.

The flexible polyurethane foams disclosed herein have properties that would be expected of a flexible polyurethane foam produced solely from fossil based polyols.

For example, the air permeability of the flexible polyurethane foam disclosed herein has a comparable air permeability to a fossil based flexible polyurethane foam.

In some embodiments, the flexible polyurethane foam has an air permeability of about 2 to about 2500 L/m²/s. For example, the porosity may be about 50 to about 2000 L/m²/s, or about 100 to about 1000 L/m²/s. Porosity is measured using ISO 9237:1995.

ISO 9237:1995 is a method to test the air permeability of a material (the method was designed for fabrics)—the velocity of air flow passing perpendicularly through a foam under specified conditions of test area, pressure drop and time.

A sample is clamped over an orifice, that can vary from 5 to 100 cm², to achieve a pressure drop of 200 Pa. The air velocity required to achieve this (L/m²/s) is recorded. In this disclosure, this air velocity may be referred to as a measurement for air permeability or as a measurement for porosity. As one example, the air permeability is measured according to ISO 9237 at 200 mbar, thickness of 15 mm to give an air permeability of 100-2000 L/m²s.

Air permeability of a rigid or semi-rigid foam will generally be decreased compared with that of a flexible foam.

Generally, increasing the air permeability of a polyurethane foam will increase the elongation at break and increase the resilience.

In some embodiments, the flexible polyurethane foam may be described as an open cell flexible polyurethane foam. In some embodiments, the flexible polyurethane foam has more than about 90% open cells, for example more than about 95% open cells.

The density of the flexible polyurethane foam disclosed herein is comparable to the density of a fossil based flexible polyurethane foam. In some embodiments, the density of the flexible polyurethane foam is about 15 to 80 kg/m³. For example, the density may be about to 60 kg/m³, or about 30 to 40 kg/m³. In some embodiments, the density of the flexible polyurethane foam is about 30 kg/m³.

The compressive strength of the flexible polyurethane foam disclosed herein is comparable to the compressive strength of a fossil based flexible polyurethane foam. In some embodiments, the compressive strength of the flexible polyurethane foam is about 1.5 kPa to about 9 kPa, for example about 2 kPa to about 8 KPa, or about 4 kPa to about 6 kPa. In some embodiments, the compressive strength of the flexible polyurethane foam is at least about 1.5 kPa, or at least about 2 kPa, or at least about 4 kPa, or at least about 6 kPa, or at least about 8 kPa. Compressive strength is measured using ISO 3386 at 40% compression.

In some embodiments, hardness of the flexible polyurethane foam disclosed herein is comparable to the hardness of a fossil based flexible polyurethane foam. In some embodiments, the hardness of the flexible polyurethane foam is about 2 kPa to about 8 KPa, for example about 4 kPa to about 6 kPa. In some embodiments, the hardness of the flexible polyurethane foam is at least about 2 kPa, or at least about 4 kPa, or at least about 6 kPa.

In some embodiments, the tensile strength of the flexible polyurethane foam disclosed herein is comparable to the tensile strength of a fossil based flexible polyurethane foam. In some embodiments, the tensile strength of the flexible polyurethane foam is >100 kPa.

In some embodiments, the elongation at break of the flexible polyurethane foam disclosed herein is comparable to the elongation at break of a fossil based flexible polyurethane foam. In some embodiments, the elongation at break of the flexible polyurethane foam is at least about 100%, or at least about 125%, or at least about 150%, or at least about 200%, or at least about 250%. In some embodiments, the elongation at break of the flexible polyurethane foam disclosed here in up to about 300%.

In some embodiments, the flexible polyurethane foam disclosed herein is derived solely from sustainable polyols. As outlined above, a biopolyol may be referred to as a sustainable polyol and a recycled polyol composition may be referred to as comprising a sustainable polyol.

In some embodiments, the flexible polyurethane foam disclosed herein has a bio-based carbon content as determined by ¹⁴C isotope analysis of from about 1% to about 100%. In some embodiments, the bio-based carbon content as determined by ¹⁴C isotope analysis is about 1.3% to about 46%. For example, from 10% to about 20%.

### EXAMPLES

The following examples are specific embodiments of the present invention but are not intended to limit the present invention.

### Example 1

A biopolyol, a recycled polyol composition, one or more isocyanates, catalysts, water and additives were mixed together in the proportions outlined in Table 1, to form a mixture. The mixture was foamed by small scale machine foaming then left to cure for 24 hours to produce a flexible polyurethane foam.

TABLE 1

| | A | B | C | D | E | F |
|---|---|---|---|---|---|---|
| Description | (parts) | (parts) | (parts) | (parts) | (parts) | (parts) |
| Re-polyol | 80.00 | 80.00 | 80.00 | 80.00 | 80.00 | 80.00 |
| composition | | | | | | |
| Biopolyol | 20.00 | 20.00 | 20.00 | 20.00 | 20.00 | 20.00 |
| TDI | 54.10 | 49.79 | 54.10 | 47.28 | 47.27 | 47.27 |
| Tin catalyst in | 1.20 | 1.25 | 1.25 | 1.25 | 1.25 | 1.25 |
| diluent | | | | | | |
| Water | 3.60 | 3.60 | 3.60 | 3.60 | 3.60 | 3.60 |
| Amine catalyst | 0.80 | 0.80 | 0.80 | 0.80 | 0.80 | 0.80 |
| surfactants | 1.00 | 1.00 | 1.00 | 1.00 | 1.00 | 1.00 |
| Flame | 7.00 | 0.00 | 7.00 | 0.00 | 0.00 | 0.00 |
| lamination aid | | | | | | |
| Halogen free | 0.00 | 2.50 | 2.50 | 0.00 | 0.00 | 0.00 |
| flame retardant | | | | | | |
| additive | | | | | | |

All flexible polyurethane foams produced had good properties which were comparable with flexible polyurethane foams produced from fossil based polyols.

### Example 2

A biopolyol, a recycled polyol composition, a fossil based polyol, one or more isocyanates, catalysts, water and additives were mixed together in the proportions outlined in Table 2, to form a mixture. The mixture was foamed on a slabstock foaming machine then left to cure for 24 hours to produce a flexible polyurethane foam.

TABLE 2

| Ingredient | Amount (parts) |
|---|---|
| Fossil based polyol | 60 |
| Re-polyol composition | 20 |
| Biopolyol | 20 |
| TDI | 45 |
| Tin catalyst | 0.17 |
| Amine Catalyst | 0.68 |
| Water | 3.35 |
| Surfactant | 0.9 |

The flexible polyurethane foam produced had good properties which were comparable with flexible polyurethane foams produced from fossil based polyols.

### Example 3

A biopolyol, a recycled polyol composition, a fossil based polyol, one or more isocyanates, catalysts, water and additives were mixed together in the proportions outlined in Table 3, to form a mixture. The mixture was foamed by small scale slabstock foaming then left to cure for 24 hours to produce a flexible polyurethane foam.

TABLE 3

| Ingredient | Amount (parts) |
|---|---|
| Re-polyol composition | 70 |
| Biopolyol | 30 |
| Isocyanate | 53.63 |
| Catalyst | 0.48 |
| Surfactant | 1.52 |
| Water | 4.0 |
| Additives | 4.7 |

The flexible polyurethane foam produced had good properties e.g. in support, density and damping which were comparable with flexible polyurethane foams produced from fossil based polyols.

### Example 4

A biopolyol, a recycled polyol composition, a fossil based polyol, one or more isocyanates, catalysts, water and additives were mixed together in the proportions outlined in Table 4, to form a mixture. The mixture was foamed by small scale slabstock foaming then left to cure for 24 hours to produce a flexible polyurethane foam comparable with the production process.

TABLE 4

| Ingredient | Amount (parts) |
|---|---|
| Fossil based polyol | 70 |
| Re-polyol composition | 20 |
| Biopolyol | 10 |
| Isocyanate | 39.24 |
| Catalyst | 0.5 |
| Surfactant | 0.7 |
| Water | 3.0 |
| Additives | 7.9 |

The flexible polyurethane foam produced had good properties e.g. in resilience, comfort, durability which were comparable with flexible polyurethane foams produced from fossil based polyols.

### Example 5

A biopolyol, a recycled polyol composition, a fossil based polyol, a filled polyol, one or more isocyanates, catalysts, and water were mixed together in the proportions outlined in Table 5, to form a mixture. The mixture was foamed by small scale slabstock foaming then left to cure for 24 hours to produce a flexible polyurethane foam comparable with the production process.

| Ingredient | Amount (parts) |
|---|---|
| Fossil based polyol | 40 |
| Re-polyol composition | 20 |
| Biopolyol | 20 |
| Filled polyol | 20 |
| Isocyanate | 46.19 |
| Catalyst | 0.773 |
| Surfactant | 0.75 |
| Water | 3.25 |

The flexible polyurethane foam produced had good properties which were comparable with flexible polyurethane foams produced from fossil based polyols

For the avoidance of any doubt, the terms “a”, “an” and “the” are intended, unless specifically indicated otherwise or the context requires otherwise, to include plural alternatives, e.g., at least one.

“Optional” or “optionally” means that the subsequently described event or circumstance can or cannot occur, and that the description includes instances where the event or circumstance occurs and instances where it does not.

Various other modifications to the present invention will be readily apparent to those skilled in the art.

1. A process for preparing flexible polyurethane foam comprising:
mixing together a biopolyol, a recycled polyol composition, an isocyanate, a catalyst, water and optionally additives to form a mixture;
foaming the mixture to form a foamed mixture; and
curing the foamed mixture;
wherein the ratio of biopolyol to recycled polyol composition is from about 65:35 to about 5:95.

2. The process according to claim 1, wherein the ratio of biopolyol to recycled polyol composition is about 60:40, or about 55:45, or about 50:50, or about 45:55, or about 40:60, or about 35:65, or about 30:70, or about 25:75, or about 20:80, or about 15:85, or about 10:90.

3. The process according to claim 1, wherein the density of the sustainable polyurethane flexible foam is about 15 to 95 kg/m³.

4. The process according to claim 1, wherein the biopolyol is selected from the group consisting of a soy based polyol, a sunflower based polyol, a palm based polyol, a rapeseed based polyol, a castor based polyol, a peanut based polyol, tall oil based polyol, and a canola based polyol.

5. The process according to claim 1, wherein the recycled polyol composition is derived from recycled polyurethane foam waste.

6. The process according to claim 1, wherein the recycled polyol composition comprises about 30 to about 100 wt % recycled polyol and about 0 to about 70 wt % fossil based polyol.

7. The process according to claim 1, wherein the flexible polyurethane foam is derived solely from sustainable polyols.

8. The process according to any one of claim 1, comprising mixing together:
5-65 parts biopolyol
35-95 parts recycled polyol composition
0-5 parts fossil based polyol
40-60 parts isocyanate
1-3 parts catalyst
2-5 parts water
0-20 parts additives.
wherein the total amount of polyol (recycled polyol composition, biopolyol, and fossil based polyol) is 100 parts.

9. The process according to claim 1, wherein the catalyst is a blowing catalyst, and/or a gelling catalyst.

10. The process according to claim 1, wherein the additive is selected from the group consisting of foam stabilizer, surfactant, cell regulator, colour, chain extender/cross linker, filler, flame lamination aid, flame retardant, porosity enhancer, and cell opener.

11. A flexible polyurethane foam prepared by the process of claim 1.

12. A flexible polyurethane foam derived from a biopolyol, a recycled polyol composition, and an isocyanate, wherein the ratio of biopolyol to recycled polyol composition is from about 65:35 to about 5:95.

13. The flexible polyurethane foam according to claim 11, wherein the foam has a bio-based carbon content as determined by ¹⁴C isotope analysis of from about 1.3% to about 46%.

14. The flexible polyurethane foam according to claim 11, wherein the foam has a compressive strength of about 1.5 kPa to about 9 kPa.

15. The flexible polyurethane foam according to claim 11, wherein the foam has an air permeability of about 2 to about 2500 L/m²/s.

16. A polyol composition for preparing a flexible polyurethane foam, the polyol composition comprising;
5-65 parts biopolyol;
35-95 parts recycled polyol composition; and
0-5 parts fossil based polyol.
wherein the total amount of polyol (recycled polyol composition, biopolyol, and fossil based polyol) is 100 parts.
